(19) United States
(12) Patent Application Publication
(10) Pub. No.: US 2025/0277907 A1
(43) Pub. Date: Sep. 4, 2025

(54) INFORMATION PROCESSING DEVICE, INFORMATION PROCESSING METHOD, AND NON-TRANSITORY COMPUTER READABLE STORAGE MEDIUM

(71) Applicant: Oki Electric Industry Co., Ltd., Tokyo (JP)

(72) Inventors: Michiyo MATSUI, Tokyo (JP); Kazuki KOBAYASHI, Tokyo (JP)

(73) Assignee: Oki Electric Industry Co., Ltd., Tokyo (JP)

(21) Appl. No.: 19/008,975

(22) Filed: Jan. 3, 2025

(30) Foreign Application Priority Data
Feb. 29, 2024 (JP) 2024-029341

(51) Int. Cl. G01S 17/89; G01S 17/42; G01S 19/51; G06T 7/246; G06T 7/73

(52) U.S. Cl. CPC G01S 17/89; G01S 17/42; G01S 19/51; G06T 7/246; G06T 7/73; G06T 2207/10028; G06T 2207/20092

(57) ABSTRACT

It is desirable to provide a technology that makes it possible to improve accuracy of determination of an area where an object exists while saving users time and effort. An information processing device is provided. The information processing device includes a sensor data acquisition section configured to acquire sensor data obtained by a sensor and a determination section configured to determine whether a representative position of an object region exists in a first area or in a second area, on a basis of the sensor data and a criterion function that serves as a standard for determining the area where the representative position exists.

### CROSS REFERENCE TO RELATED APPLICATION(S)

This application is based upon and claims benefit of priority from Japanese Patent Application No. 2024-029341, filed on Feb. 29, 2024, the entire contents of which are incorporated herein by reference.

### BACKGROUND

The present invention relates to an information processing device, an information processing method, and a non-transitory computer readable storage medium.

In recent years, technologies of detecting objects on the basis of data (hereinafter, also referred to as “sensor data”) obtained by sensors have been known (for example, see JP5647458 B). Results of the object detection may be utilized in various situations. For example, technologies of determining whether or not an object exists in a preset area (hereinafter, also referred to as “detection area”) on the basis of the results of object detection have been known. For example, such technologies mainly assume that the objects are people.

More specifically, such a technology uses a plurality of distance sensors installed along an edge of a station platform to track objects, and determines that an object has dropped from the train platform if vanishment of the tracking object from the detection area is detected.

### SUMMARY

However, the vanishment of the tracking object from the detection does not always mean a dropping of the object from the train platform. Therefore, improvement of determination accuracy cannot be achieved if it is determined that the object has dropped from the train platform just because vanishment of the object from the detection area is detected without recognizing a status of the object vanished from the detection area.

In addition, this requires user to take extra work to set the detection area. In particular, in cases where the train platform is curved, it is difficult to set a plurality of detection areas all at once with regard to the plurality of distance sensors installed at the edge of the train platform, and it is necessary to set respective detection areas for plurality of distance sensors. Accordingly, this requires users to take a lot of work to set the detection areas.

Accordingly, the present invention is made in view of the aforementioned issues, and an object of the present invention is to provide a technology that makes it possible to improve accuracy of determination of an area where an object exists while saving users time and effort.

In order to solve the above problems, according to one aspect of the present invention, an information processing device is provided. The information processing device includes a sensor data acquisition section configured to acquire sensor data obtained by a sensor and a determination section configured to determine whether a representative position of an object region exists in a first area or in a second area, on a basis of the sensor data and a criterion function that serves as a standard for determining the area where the representative position exists.

The information processing device may include a processing area clipping section configured to clip the sensor data from a predecided processing area. The determination section may determine whether the representative position exists in the first area or in the second area, on a basis of the sensor data and the criterion function.

The processing area may include a first processing area in a sensor coordinate system and a second processing area in the sensor coordinate system, the first processing area corresponding to an upper area with respect to a predetermined horizontal plane perpendicular to a vertical direction in a real space, the second processing area corresponding to a lower area with respect thereto.

The first processing area may exist in one of two areas obtained by splitting a sensor coordinate space or a sensor coordinate plane by a shape corresponding to the criterion function, and the second processing area may exist in another of the two areas.

The determination section may include an object detection section configured to detect the object region on a basis of the sensor data and detect the representative position of the object region, and an area determination section configured to determine whether the representative position exists in the first area or in the second area, on a basis of the representative position and the criterion function.

The area determination section may acquire an output value output from the criterion function in response to input of the representative position into the criterion function as an input value and determine whether the representative position exists in the first area or in the second area on a basis of the output value.

The object detection section may detect a first representative position of a first object region at a first time and a second representative position of a second object region at a second time that is after the first time. The determination section may include an object tracking section configured to calculate a distance between the first representative position and the second representative position and associate the first representative position with the second representative position in a case where the distance is smaller than a threshold. The determination section may include a movement determination section configured to determine whether or not a same object has moved between the first area and the second area, on a basis of whether the first representative position and the second representative position that are associated with each other exist in a same area or in different areas.

In a case where it is determined that the first representative position and the second representative position that are associated with each other exist in the different areas, the movement determination section may determine whether or not the same object has moved between the first area and the second area, on a basis of whether or not a difference between a first statistical process result of representative positions of an object region of the same object at or before the first time and a second statistical process result of representative positions of an object region of the same object at or after the second time is larger than a predetermined value.

A coordinate axis may be set along a vertical direction in a real space. The first statistical process result may be an average value of coordinates on the coordinate axis with regard to the representative positions of the object region of the same object at or before the first time. The second statistical process result may be an average value of coordinates on the coordinate axis with regard to the representative positions of the object region of the same object at or after the second time.

The object detection section may detect a first representative position of a first object region at a first time and a second representative position of a second object region at a second time that is after the first time. The determination section may include an object tracking section configured to calculate a distance between the first representative position and the second representative position and associate the first representative position with the second representative position in a case where the distance is smaller than a threshold. A coordinate axis may be set along a vertical direction in a real space. The determination section may include a movement determination section configured to determine whether or not a same object has moved between the first area and the second area on a basis of a coordinate on the coordinate axis with regard to the first representative position and a coordinate on the coordinate axis with regard to the second representative position that are associated as the representative positions of the object regions of the same object in a sensor coordinate system based on the sensor.

The movement determination section may determine whether or not the same object has moved between the first area and the second area on a basis of whether or not a difference between the coordinate on the coordinate axis with regard to the first representative position and the coordinate on the coordinate axis with regard to the second representative position is larger than a predetermined value. The criterion function may be decided by approximation based on position information input by a user or position information obtained by a GNSS sensor or a laser scanner.

The second area may include a third area and a fourth area. The determination section may determine whether the representative position exists in the third area or in the fourth area on a basis of the sensor data and another criterion function obtained by adding a constant to the criterion function.

The approximation may be polynomial approximation. The criterion function may be a function expressed by using a polynomial decided by the polynomial approximation.

The criterion function may be decided by approximation based on the position information input by the user.

The position information obtained by the GNSS sensor or the laser scanner may be converted into position information in a sensor coordinate system based on the sensor. The criterion function may be decided by approximation based on the position information in the sensor coordinate system.

In order to solve the above problems, according to another aspect of the present invention, an information processing method that is executed by a computer is provided. The information processing method may include acquiring sensor data obtained by a sensor and determining whether a representative position of an object region exists in a first area or in a second area on a basis of the sensor data and a criterion function that serves as a standard for determining the area where the representative position exists.

In order to solve the above problems, according to another aspect of the present invention, a non-transitory computer readable storage medium having recorded thereon a program for causing a computer to functions as a sensor data acquisition section configured to acquire sensor data obtained by a sensor and a determination section configured to determine whether a representative position of an object region exists in a first area or in a second area, on a basis of the sensor data and a criterion function that serves as a standard for determining the area where the representative position exists.

As described above, according to the present invention, it is possible to improve accuracy of determination of an area where an object exists while saving users time and effort.

### BRIEF DESCRIPTION OF THE DRAWINGS

FIG. 1 is a block diagram illustrating a functional configuration example of a criterion function decision device 1 according to a first embodiment of the present invention.

FIG. 2 is a block diagram illustrating a functional configuration example of an area determination device 2 according to the first embodiment of the present invention.

FIG. 3 is a flowchart illustrating a behavior example of the criterion function decision device 1 related to a criterion function decision phase.

FIG. 4 is a diagram illustrating an example of an input point cloud acquired in the criterion function decision phase.

FIG. 5 is a diagram illustrating an example of an approximation curve corresponding to a criterion function.

FIG. 6 is a diagram illustrating an example of the approximation curve in a sensor coordinate system.

FIG. 7 is a flowchart illustrating a behavior example of the area determination device 2 related to an area determination phase.

FIG. 8 is a block diagram illustrating a functional configuration example of an area determination device 3 according to a second embodiment of the present invention.

FIG. 9 is a flowchart illustrating a behavior example of the area determination device 3 in an area determination phase.

FIG. 10 is a flowchart illustrating the behavior example of the area determination device 3 in the area determination phase.

FIG. 11 is a diagram illustrating an example of processing areas identified by a processing area clipping section 200.

FIG. 12 is a diagram for describing a case where a same object falls on a railway track area from a platform area.

FIG. 13 is a diagram for describing a first modification.

FIG. 14 is a diagram for describing a second modification.

FIG. 15 is a diagram for describing a third modification.

FIG. 16 is a diagram illustrating a hardware configuration of an information processing device 900 serving as an example of the area determination device 2 according to the embodiment of the present invention.

### DETAILED DESCRIPTION OF THE EMBODIMENT(S)

Hereinafter, referring to the appended drawings, a preferable embodiments of the present invention will be described in detail. Note that, in this specification and the appended drawings, structural elements that have substantially the same function and structure are denoted with the same reference signs, and repeated explanation of these structural elements will be omitted.

### 1. FIRST EMBODIMENT

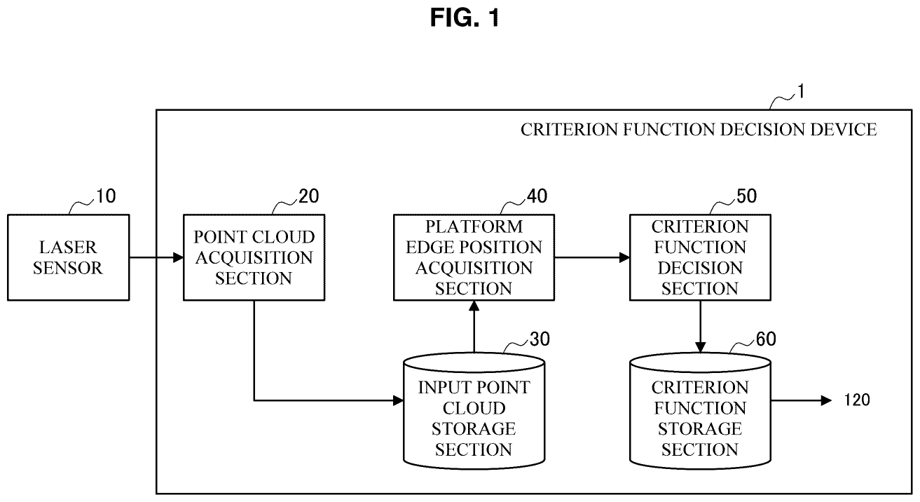

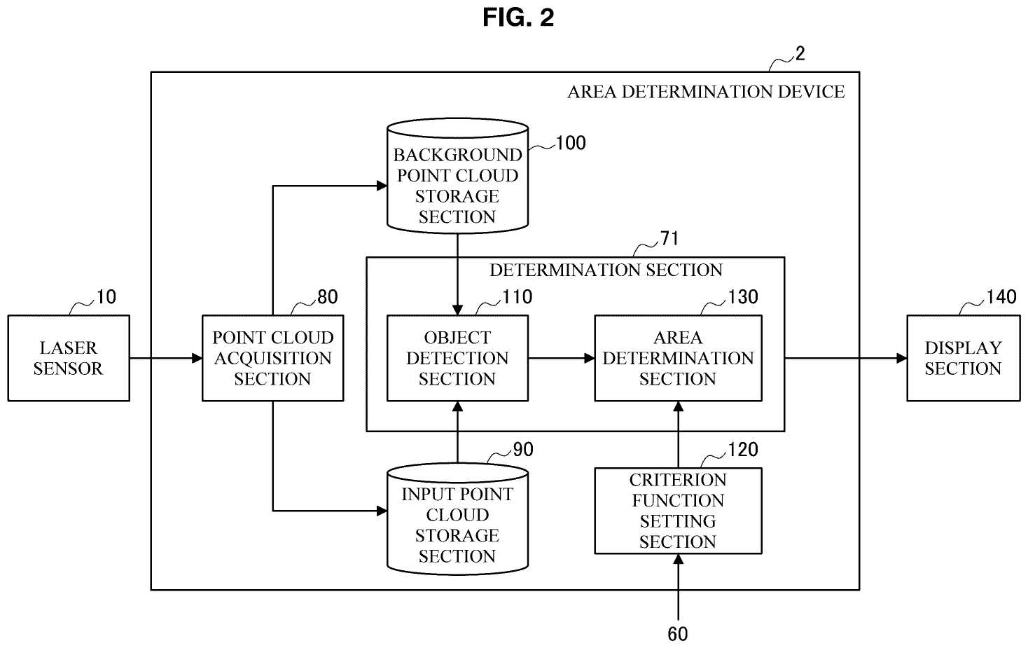

First, a first embodiment of the present invention will be described in detail. An information processing system according to the first embodiment of the present invention includes a laser sensor 10 (FIG. 1 and FIG. 2), a criterion function decision device 1 (FIG. 1), and an area determination device 2 (FIG. 2).

The first embodiment of the present invention mainly assumes cases where an object (hereinafter, also referred to as a “target object”) whose position can be determined by the area determination device 2 is a human. However, the target object is not limited to humans. For example, the target object may be a mobile object other than humans (for example, vehicles, ships, animals other than humans, robots, and the like).

According to the first embodiment of the present invention, the criterion function decision device 1 decides a criterion function that serves as a standard for determining an area where the target object exists, and the area determination device 2 determines the area where the target object exists on the basis of the criterion function. To decide the criterion function, a criterion position is used.

The first embodiment of the present invention mainly assumes a case where the criterion position is an edge position (hereinafter, simply referred to as “platform edge position”) of a train station platform (hereinafter, simply referred to as “platform”). In the case where the criterion position is the platform edge position, it may be determined whether the target object exists in a platform area or in a railway track area. However, as will be described later, the criterion position is not limited to the platform edge position.

The first embodiment of the present invention mainly assumes a case where the criterion function decision device 1 and the area determination device 2 are implemented by different devices. However, it is also possible to implement the criterion function decision device 1 and the area determination device 2 by a same device.

### 1-1. Configuration Example of Criterion Function Decision Device 1

FIG. 1 is a block diagram illustrating a functional configuration example of the criterion function decision device 1 according to the first embodiment of the present invention. As illustrated in FIG. 1, the criterion function decision device 1 according to the first embodiment of the present invention includes a point cloud acquisition section 20, an input point cloud storage section 30, a platform edge position acquisition section 40, a criterion function decision section 50, and a criterion function storage section 60. In addition, the criterion function decision device 1 is connected to the laser sensor 10 and the area determination device 2. First, the laser sensor 10 will be described, and then the functional configuration example of the criterion function decision device 1 will be described with reference to FIG. 1.

### (Laser Sensor 10)

The laser sensor 10 is a sensor that emits laser light and measures a three-dimensional position of an object as sensor data on the basis of reflection of the laser light. For example, the laser sensor 1 may be installed at a position (for example, at a platform, around the platform, or other positions) where it is possible to measure the target object and the platform edge. The laser sensor may also be referred to as a laser imaging, detection, and ranging (LiDAR) sensor.

The laser sensor 10 corresponds to an example of a sensor that obtains a three-dimensional position of an object as sensor data. Therefore, instead of the laser sensor 10, it is possible to use various kinds of sensors (for example, ranging sensor) other than the laser sensor. For example, the sensor may be a radar (for example, millimeter-wave radar or the like) that uses electromagnetic waves instead of the laser light. Alternatively, the sensor may be a sonar that uses acoustic waves instead of the laser light. Hereinafter, the sensor data obtained by the laser sensor 10 will also be referred to as “point cloud data” or “point cloud”.

### (Criterion Function Decision Device 1)

The criterion function decision device 1 is an information processing device that is implemented by a computer. For example, the point cloud acquisition section 20, the platform edge position acquisition section 40, and the criterion function decision section 50 may be implemented by control units (not illustrated). On the other hand, the input point cloud storage section 30 and the criterion function storage section 60 may be implemented by storage sections (not illustrated).

The control section (not illustrated) includes a central processing unit (CPU) or the like, and the functions thereof may be realized by a program stored in a non-volatile storage device being expanded and executed in a random access memory (RAM) by the CPU. At this time, it is also possible to provide a computer-readable storage medium having the program recorded thereon. Alternatively, the control section (not illustrated) may be configured by dedicated hardware, or may be configured by a combination of a plurality of pieces of hardware.

The storage section (not illustrated) is a storage device that makes it possible to store programs and data for operating the control section (not illustrated). It is also possible for the storage section (not illustrated) to temporarily store various kinds of data that are necessary for processes of operation of the control section (not illustrated). For example, the storage device may be a non-volatile storage device.

### (Point Cloud Acquisition Section 20)

The point cloud acquisition section 20 acquires point cloud data (second sensor data) obtained by the laser sensor 10 from the laser sensor 10 as an input point cloud. The point cloud acquisition section 20 outputs the input point cloud acquired from the laser sensor 10, to the input point cloud storage section 30.

### (Input Point Cloud Storage Section 30)

The input point cloud storage section 30 stores the input point cloud output from the point cloud acquisition section 20. In addition, the input point cloud storage section outputs the input point cloud to the platform edge position acquisition section 40.

### (Platform Edge Position Acquisition Section 40)

The platform edge position acquisition section 40 acquires a platform edge position. The platform edge position acquisition section 40 may acquire the platform edge position in any way. As an example, the platform edge position acquisition section may use a point cloud display application or the like to display the input point cloud on a predetermined display and may acquire, as the platform edge position, a position input by a user into a predetermined input device on the basis of the input point cloud displayed on the display. Alternatively, as will be described later, it is also possible for the platform edge position acquisition section 40 to automatically acquire the platform edge position without the manual operation by the user. The platform edge position acquisition section 40 outputs the platform edge position to the criterion function decision section 50.

### (Criterion Function Decision Section 50)

The criterion function decision section 50 decides a criterion function on the basis of the platform edge position. For example, the criterion function decision section 50 may decide the criterion function by approximation based on the platform edge position. Next, a case where the approximation performed by the criterion function decision section 50 is polynomial approximation will be described. In this case, the criterion function may be a function expressed by using a polynomial decided by the polynomial approximation. In other words, the criterion function may be expressed by polynomial coefficients that are coefficients of respective dimensions involved in the polynomial.

Note that, in this specification, the polynomial is not limited to a case where the number of terms is two or more, but may include a case where the number of terms is 1. In addition, in this specification, the polynomial may be an expression whose highest degree is zero dimension or one or more dimension. The criterion function decision section 50 outputs the decided criterion function to the criterion function storage section 60.

### (Criterion Function Storage Section 60)

The criterion function storage section 60 stores the criterion function output from the criterion function decision section 50. The criterion function stored in the criterion function storage section 60 is output to a criterion function setting section 120 included in the area determination device 2.

The functional configuration example of the criterion function decision device 1 according to the first embodiment of the present invention has been described above.

### 1-2. Configuration Example of Area Determination Device 2

FIG. 2 is a block diagram illustrating a functional configuration example of an area determination device 2 according to the first embodiment of the present invention. As illustrated in FIG. 2, the area determination device 2 according to the first embodiment of the present invention includes a determination section 71, a point cloud acquisition section 80, an input point cloud storage section 90, a background point cloud storage section 100, a criterion function setting section 120. The determination section 71 includes an object detection section 110 and an area determination section 130. In addition, the area determination device 2 is connected to the criterion function decision device 1 and a display section 140. First, a functional configuration example of the area determination device 2 will be described, and then the display section 140 will be described.

### (Area Determination Device 2)

The area determination device 2 is an information processing device that is implemented by a computer. For example, the determination section 71, the point cloud acquisition section 80, and the criterion function setting section 120 may be implemented by control units (not illustrated). On the other hand, the input point cloud storage section 90 and the background point cloud storage section 100 may be implemented by storage sections (not illustrated).

The control section (not illustrated) includes a central processing unit (CPU) or the like, and the functions thereof may be realized by a program stored in a non-volatile storage device being expanded and executed in a random access memory (RAM) by the CPU. At this time, it is also possible to provide a computer-readable storage medium having the program recorded thereon. Alternatively, the control section (not illustrated) may be configured by dedicated hardware, or may be configured by a combination of a plurality of pieces of hardware.

The storage section (not illustrated) is a storage device that makes it possible to store programs and data for operating the control section (not illustrated). It is also possible for the storage section (not illustrated) to temporarily store various kinds of data that are necessary for processes of operation of the control section (not illustrated). For example, the storage device may be a non-volatile storage device.

### (Point Cloud Acquisition Section 80)

From the laser sensor 10, the point cloud acquisition section 80 acquires, as a background point cloud, point cloud data (third sensor data) obtained by the laser sensor 10 in a state where a measurement range of the laser sensor 10 includes no target object. The point cloud acquisition section 80 outputs the background point cloud acquired from the laser sensor 10, to the background point cloud storage section 100.

After outputting the background point cloud to the background point cloud storage section 100, the point cloud acquisition section 80 acquires point cloud data (first sensor data) obtained by the laser sensor 10, from the laser sensor 10 as an input point cloud. The point cloud acquisition section 80 outputs the input point cloud acquired from the laser sensor 10, to the input point cloud storage section 90.

### (Input Point Cloud Storage Section 90)

The input point cloud storage section 90 stores the input point cloud output from the point cloud acquisition section 80. In addition, the input point cloud storage section 90 outputs the input point cloud to the object detection section 110.

### (Background Point Cloud Storage Section 100)

The background point cloud storage section 100 stores the background point cloud output from the point cloud acquisition section 80. In addition, the background point cloud storage section 100 outputs the background point cloud to the object detection section 110.

### (Determination Section 71)

The determination section 71 determines whether a representative position of a region (hereinafter, also referred to as an “object region”) including a target object exists in a first area or in a second area, on the basis of the input point cloud output from the input point cloud storage section 90 and a criterion function set by the criterion function setting section 120. Hereinafter, the first area will also be referred to as a “platform area”, and the second area will also be referred to as a “railway track area”. The criterion function is a function that serves as a standard for determining the area where the representative position of the object region exists.

More specifically, the determination section 71 determines whether the representative position of the object region exists in the platform area or in the railway track area, on the basis of the background point cloud output from the background point cloud storage section 100, the input point cloud output from the input point cloud storage section 90, and the criterion function set by the criterion function setting section 120. The determination section 71 outputs a determination result to the display section 140.

### (Object Detection Section 110)

The object detection section 110 detects the object region on the basis of the input point cloud output from the input point cloud storage section 90. More specifically, the object detection section 110 detects the object region on the basis of the background point cloud output from the background point cloud storage section 100 and the input point cloud output from the input point cloud storage section 90. The object detection section 110 detects the representative position of the object region from the detected object region. For example, the representative position of the object region may be a center position of the object region. The object detection section 110 outputs the representative position of the object region to the area determination section 130.

### (Criterion Function Setting Section 120)

The criterion function setting section 120 sets the criterion function. More specifically, the criterion function setting section 120 may set the criterion function by acquiring the criterion function output from the criterion function storage section 60. The criterion function setting section 120 outputs the set criterion function to the area determination section 130.

### (Area Determination Section 130)

The area determination section 130 determines whether the representative position of the object region exists in the platform area or in the railway track area, on the basis of the representative position of the object region and the criterion function. More specifically, the area determination section 130 acquires an output value output from the criterion function in response to input of the representative position of the object region into the criterion function as an input value. Next, the area determination section 130 obtains an area determination result by determining whether the representative position of the object region exists in the platform area or in the railway track area on the basis of the output value.

The area determination section 130 outputs the area determination result to the display section 140. This makes it possible to control display of the area determination result on the display section 140. For example, it is possible for a person to take some measures against the target object when the person visually recognizes an area determination result indicating that the representative position of the object region is in the railway track area.

### ((Display Section 140))

The display section 140 displays the determination result output from the area determination section 130. For example, the display section 140 may include a lamp to show a determination result indicating that the representative position of the object region exists inside the railway track area by turning on the lamp. Alternatively, the display section 140 may be configured by a display to showing the determination result indicating that the representative position of the object region exists inside the railway track area by displaying a predetermined color (for example, red) on the display.

Note that, the installation position of the display section 140 is not specifically limited. For example, the display section 140 may be installed on the platform. Alternatively, the display section 140 may be installed in a station office for station staffs. Alternatively, the display section 140 may be installed in a monitoring center where observers monitor train service status.

The functional configuration example of the area decision device 2 according to the first embodiment of the present invention has been described above.

### 1-3. Behavior Example Related to Criterion Function Decision Phase

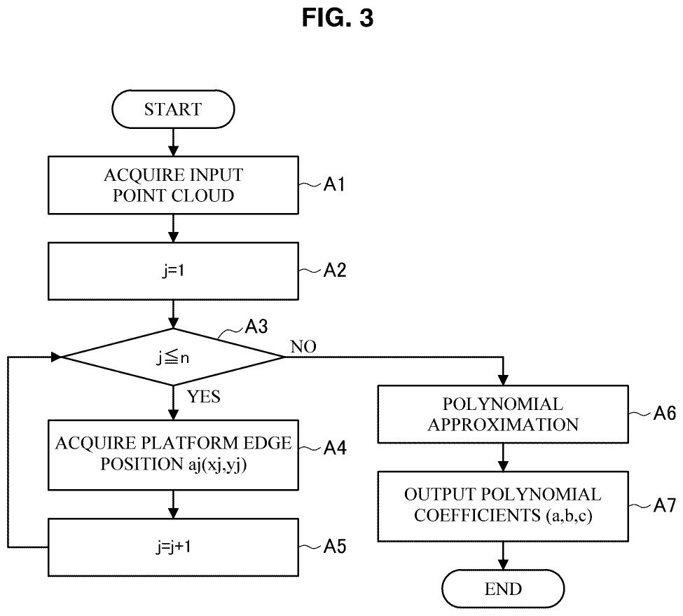

Next, a behavior example of the information processing system according to the first embodiment of the present invention will be described. The behavior example of the information processing system is divided into a first phase and a second phase that is performed after the first phase. The first phase is a criterion function decision phase. The second phase is an area determination phase. First, a behavior example of the criterion function decision device 1 related to the criterion function decision phase will be described with reference to FIG. 3 to FIG. 6 (FIG. 1 will also be referenced as appropriate).

FIG. 3 is a flowchart illustrating the behavior example of the criterion function decision device 1 related to the criterion function decision phase. As illustrated in FIG. 3, in the criterion function decision phase, the point cloud acquisition section 20 acquires point cloud data obtained by the laser sensor 10 from the laser sensor 10 as an input point cloud (Step A1). The point cloud acquisition section 20 outputs the input point cloud acquired from the laser sensor 10, to the input point cloud storage section 30. The input point cloud storage section 30 stores the input point cloud output from the point cloud acquisition section 20. Next, the input point cloud storage section 30 outputs the input point cloud to the platform edge position acquisition section 40.

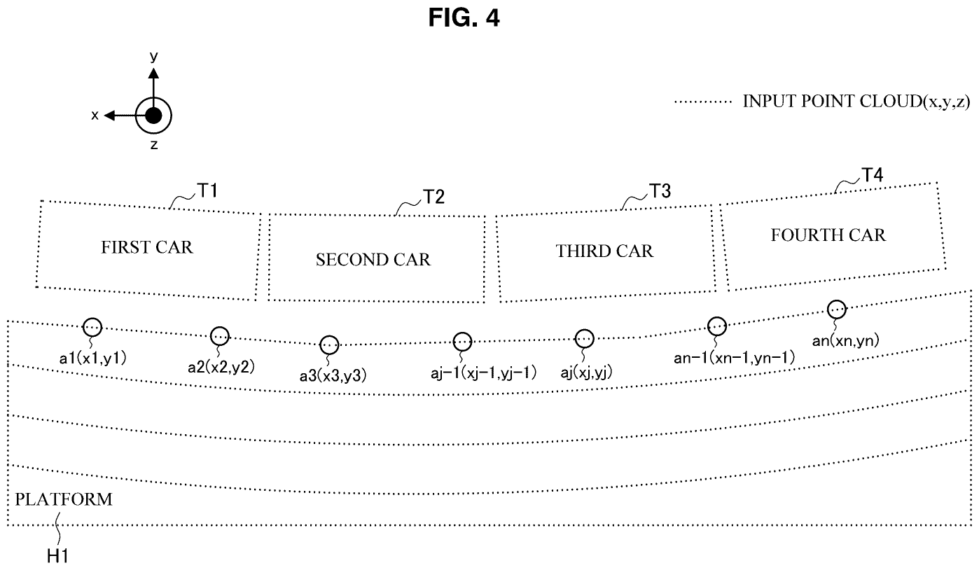

FIG. 4 is a diagram illustrating an example of the input point cloud acquired in the criterion function decision phase. As illustrated in FIG. 4, a coordinate system (hereinafter, also referred to as a “sensor coordinate system”) based on the laser sensor is expressed by an x axis, a y axis, and a z axis. In addition, the input point cloud measured by the laser sensor 10 is expressed by an x-coordinate, a y-coordinate, and a z-coordinate.

In the example illustrated in FIG. 4, the measurement range of the laser sensor includes a first car T1, a second car T2, a third car T3, a fourth car T4 of a train, and a platform H1. Surface positions thereof are obtained as an input point cloud. However, the number of cars of the train included in the measurement rage of the laser sensor 10 is not limited to 4. Alternatively, the train does not have to exist in the measurement range of the laser sensor 10.

The platform edge position acquisition section 40 sets a counter j to 1 (Step A2). Next, in a case where the counter j indicates a given threshold n or less (“YES” in Step A3), the platform edge position acquisition section 40 acquires a platform edge position aj(xj,yj) (Step A4). The threshold n is an integer that is 1 or more.

Note that, the platform edge position may include the z-coordinate. However, for ease of calculation, the following descriptions assume that the platform edge position is a position on an xy-plane and the platform edge position does not include the z-coordinate. In addition, as the position of the input point cloud, three-dimensional coordinates (x, y, z) or two-dimensional coordinates (x,y) is used appropriately depending on situations.

The platform edge position acquisition section 40 may acquire the platform edge position aj(xj,yj) in any way. As an example, the platform edge position acquisition section 40 may use the point cloud display application or the like to display the input point cloud on the predetermined display and may acquire the platform edge position aj(xj,yj) input by the user into the predetermined input device on the basis of the input point cloud displayed on the display. Alternatively, as will be described later, it is also possible for the platform edge position acquisition section 40 to automatically acquire the platform edge position aj(xj,yj) without the manual operation by the user.

The platform edge position acquisition section 40 increments the counter by 1 (Step A5), and proceeds to Step A3. In a case where the counter j indicates the given threshold n or more (“NO” in Step A3), the platform edge position acquisition section 40 proceeds to Step A6.

FIG. 4 illustrates a platform edge position a1(x1,y1), a platform edge position a2(x2,y2), a platform edge position a3(x3,y3, . . . , a platform edge position aj−1(xj−1,yj−1), a platform edge position aj(xj,yj), . . . , a platform edge position an−1(xn−1,yn−1), and a platform edge position an(xn,yn). The platform edge position acquisition section outputs a1(x1,y1) to an(xn,yn) to the criterion function decision section 50.

The criterion function decision section 50 decides a criterion function y=f(x) on the basis of the platform edge positions a1(x1,y1) to an(xn,yn). For example, the criterion function decision section 50 may decide the criterion function y=f(x by polynomial approximation based on the platform edge positions a1(x1,y1) to an(xn,yn) (Step A6). The criterion function may be expressed by polynomial coefficients that are coefficients of respective dimensions involved in the polynomial.

More specifically, the criterion function decision section 50 may decide a criterion function y=f(x) along the platform edge on the basis of the platform edge positions a1(x1,y1) to an(xn,yn). For example, in a case where a polynomial of an approximation destination (approximation result) is a quadratic expression, the criterion function y=f(x) is decided as indicated by an expression (1).

$$y = f ( x ) = {ax}^{2} + bx + c \qquad ( 1 )$$

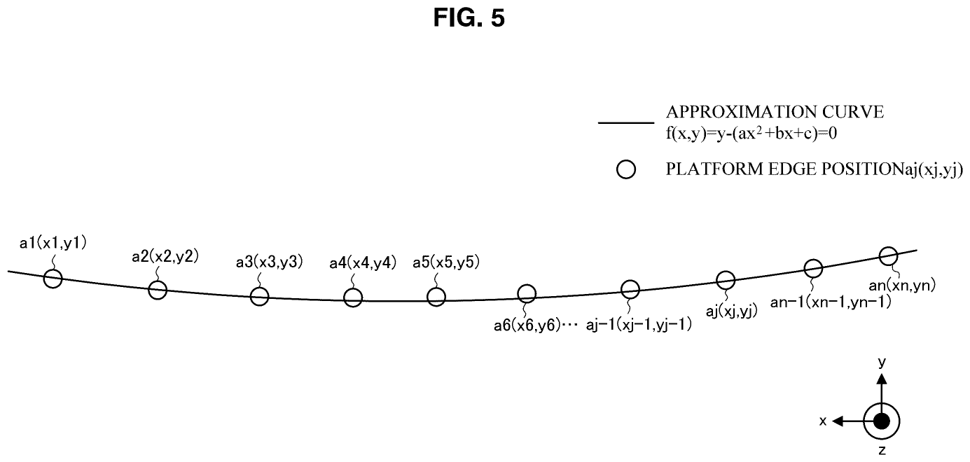

FIG. 5 is a diagram illustrating an example of an approximation curve corresponding to the criterion function. FIG. 5 illustrates the platform edge positions a1(x1,y1) to an(xn,yn). In addition, FIG. 5 illustrates the approximation curve f(x,y)=y−(ax²+bx+c)=0 corresponding to the criterion function y=f(x) approximated to the quadratic expression on the basis of the platform edge positions a1(x1,y1) to an(xn,yn). Note that, the approximation curve is an example of a shape corresponding to the criterion function. Therefore, the approximation curve corresponding to the criterion function may be replaced with another shape (for example, approximation straight line, approximation plane, approximation curved-plane, or the like).

The criterion function decision section 50 outputs the decided criterion function y=f(x)=ax²+bx+c to the criterion function storage section 60. Specifically, it is sufficient for the criterion function decision section 50 to output polynomial coefficients (a,b,c) to the criterion function storage section 60 (Step A7).

The criterion function storage section 60 stores the criterion function output from the criterion function decision section 50. Specifically, it is sufficient for the criterion function storage section 60 to store the polynomial coefficients (a,b,c) output from the criterion function decision section 50. The criterion function stored in the criterion function storage section 60 is output to a criterion function setting section 120 included in the area determination device 2.

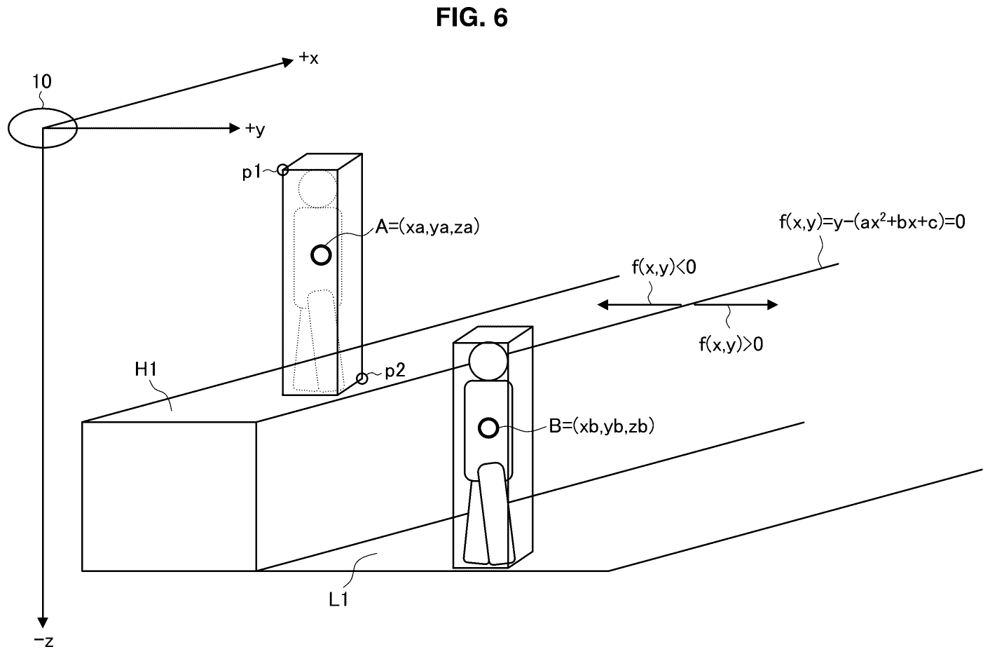

FIG. 6 is a diagram illustrating an example of the approximation curve in a sensor coordinate system. FIG. 6 illustrates the laser sensor 10 and an xyz coordinate system that is a sensor coordinate system based on the laser sensor 10. In addition, the xyz coordinate system serving as such a sensor coordinate system indicates the approximation curve f(x,y)=y−(ax²+bx+c)=0 corresponding to the criterion function y=f(x). The xyz coordinate system also indicates a platform H1 in a real space and a train running plane L1 in the real space.

As illustrated in FIG. 6, the z axis of the sensor coordinate system may be set along the vertical direction in the real space. In this case, the x axis and the y axis of the sensor coordinate system are set along the horizontal direction in the real space, and are perpendicular to the z axis of the sensor coordinate system. Also, the x axis and the y axis of the sensor coordinate system are perpendicular to each other.

As illustrated in FIG. 6, the following description mainly assumes a case where the sensor coordinate system is set in advance in such a manner that an upward direction in the vertical direction in the real space serves as a +z direction. However, the +z direction does not always have to be the upward direction in the vertical direction in the real space. For example, the sensor coordinate system may be set in advance in such a manner that a downward direction in the vertical direction in the real space serves as the +z direction.

The behavior example of the criterion function decision device 1 related to the criterion function decision phase has been described above with reference to FIG. 3 to FIG. 6 (FIG. 1 has also been referenced as appropriate).

### 1-4. Behavior Example Related to Area Determination Phase

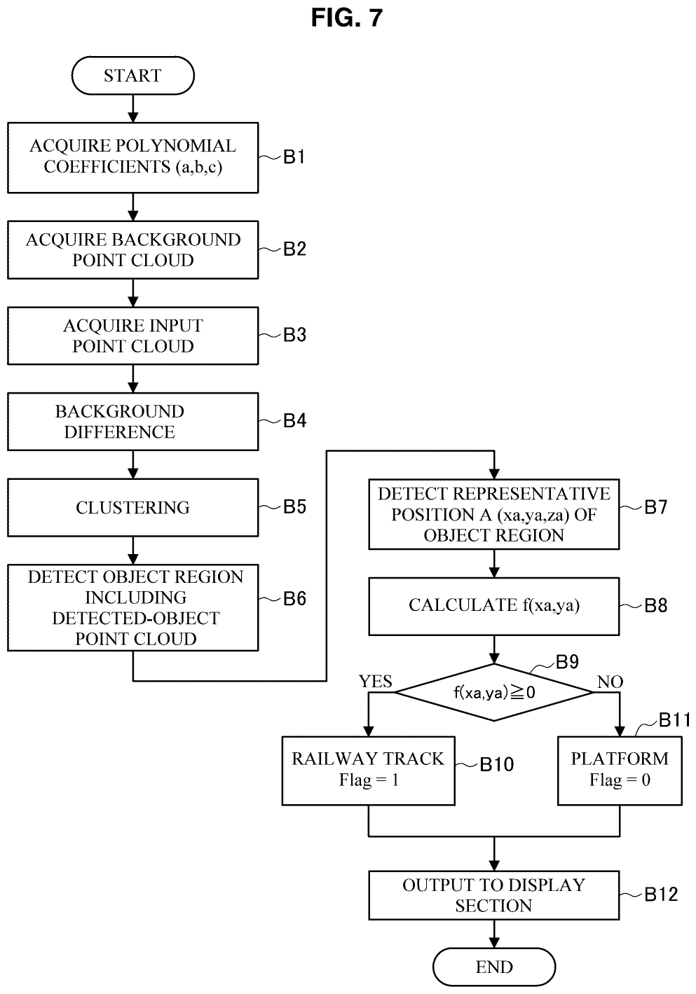

Next, a behavior example of the area determination device 2 related to the area determination phase will be described with reference to FIG. 7 (FIG. 2 and FIG. 6 will also be referenced as appropriate). As described above, the area determination phase is performed after the criterion function decision phase.

FIG. 7 is a flowchart illustrating the behavior example of the area determination device 2 related to the area determination phase. In the area determination phase illustrated in FIG. 7, the criterion function setting section 120 sets the criterion function by acquiring the criterion function output from the criterion function storage section 60. More specifically, the criterion function decision section 50 sets the criterion function by acquiring the polynomial coefficients (a,b,c) output from the criterion function storage section 60 (Step B1).

Next, from the laser sensor 10, the point cloud acquisition section 80 acquires, as the background point cloud, point cloud data obtained by the laser sensor 10 in a state where the measurement range of the laser sensor 10 includes no target object (Step B2). Here, it is assumed that the measurement range of the laser sensor 10 includes a train serving as an object other than the target object. In other words, it is assumed that the background point cloud includes respective pieces of point cloud data corresponding to the train and the platform.

The point cloud acquisition section 80 outputs the background point cloud acquired from the laser sensor 10, to the background point cloud storage section 100. Next, the background point cloud storage section 100 stores the background point cloud output from the point cloud acquisition section 80. The background point cloud storage section 100 outputs the background point cloud to the object detection section 110.

The object detection section 110 acquires the input point cloud output from the input point cloud storage section 90 (Step B3). Next, as a difference point cloud, the object detection section 110 extracts a point cloud that is not included in the background point cloud from the input point cloud, by the background difference based on the background point cloud output from the background point cloud storage section 100 and the input point cloud output from the input point cloud storage section 90 (Step B4). For example, to extract the difference point cloud, a method using the Octree module of the Point Cloud Library (PCL) or the like may be used.

Note that, it is desirable to extract a difference point cloud expressed by three-dimensional coordinates on the basis of the background point cloud expressed by three-dimensional coordinates and the input point cloud expressed by three-dimensional coordinates. However, it is also possible to extract a difference point cloud expressed by two-dimensional coordinates on the basis of a background point cloud expressed by two-dimensional coordinates and an input point cloud expressed by two-dimensional coordinates.

The object detection section 110 extracts a chunk of point clouds as a cluster by clustering the extracted difference point cloud (Step B5). For example, to cluster the difference point cloud, a method using the Kdtree module of the Point Cloud Library (PCL) or the like may be used. Note that, here, it is mainly assumed that the point clouds included in the cluster are expressed by three-dimensional coordinates. However, it is also possible to express the point clouds included in the cluster by two-dimensional coordinates.

The object detection section 110 treats the extracted cluster as a detected-object point cloud, and detects a region as an object region, the region including the detected-object point cloud and having a predetermined shape (Step B6). Here, it is mainly assumed that the detected-object point cloud and the object region are expressed by three-dimensional coordinates. In this case, the object region may have a quadrilateral prism shape whose base is a rectangular shape on a two-dimensional plane perpendicular to the z axis and whose height direction is the z axis direction. FIG. 6 illustrates an object region having the quadrilateral prism shape with a vertex p1 and a vertex p2 that are on a same diagonal. Such an object region may circumscribe a person that is an example of the target object.

Alternatively, the detected-object point cloud and the object region may be expressed by two-dimensional coordinates. In this case, the predetermined shape may be a rectangular shape on the two-dimensional plane perpendicular to the z axis. In other words, the object detection section 110 may detect a rectangular region including the detected-object point cloud (for example, a rectangular region circumscribing the detected-object point cloud) as the object region.

The object detection section 110 detects a representative position A (xa,ya,za) of the object region (Step B7). For example, FIG. 6 illustrates an example in which the object detection section 110 detects, as the representative position A (xa,ya,za), a center position of the object region having the quadrilateral prism shape with the vertex p1 and the vertex p2 that are on the same diagonal. In a similar way, FIG. 6 illustrates a representative position B (xb,yb,zb) that is the representative position after the representative position A has moved with movement of the person serving as the example of the target object. The object detection section 110 outputs the representative position A (xa,ya,za) of the object region to the area determination section 130.

The criterion function setting section 120 sets the criterion function by acquiring the criterion function output from the criterion function storage section 60. More specifically, the criterion function setting section 120 sets the criterion function f(x,y)=y−(ax²+bx+c) by acquiring the polynomial coefficients (a,b,c) output from the criterion function storage section 60. The criterion function setting section 120 outputs the criterion function f(x,y)=y−(ax²+bx+c) to the area determination section 130.

The area determination section 130 calculates an output value f(xa,ya) output from the criterion function f(x,y) (Step B8) in response to input of two-dimensional coordinates (xa,ya) of the representative position A of the object region into the criterion function f(x,y)=y−(ax²+bx+c) as an input value. This allows the area determination section 130 to obtain the output value f(xa,ya). The area determination section 130 obtains an area determination result by determining whether the representative position A of the object region exists in the platform area or in the railway track area on the basis of the output value f(xa,ya).

For example, the area determination section 130 determines whether or not the output value f(xa,ya)≥0 (zero) is satisfied, and obtains an area determination result (Step B9).

In a case where the area determination section 130 determines that the output value f(xa,ya) is 0 or more (“YES” in Step B9), it is determined that the representative position A of the object region exists in the railway track area and Flag indicating the area determination result is set to 1 (=value indicating the railway track area) (Step B10). On the other hand, in a case where the area determination section 130 determines that the output value f(xa,ya) is less than 0 (“NO” in Step B9), it is determined that the representative position A of the object region exists in the platform area and Flag indicating the area determination result is set to 0 (=value indicating the platform area) (Step B11).

The area determination section 130 outputs the area determination result to the display section 140 (Step B12) . . . . The display section 140 displays the area determination result output from the area determination section 130. For example, it is possible for a person to take some measures against the target object when the person visually recognizes the area determination result indicating that the representative position of the object region exists in the railway track area.

The behavior example of the area determination device 2 related to the area determination phase has been described with reference to FIG. 7 (FIG. 2 and FIG. 6 have also been referenced as appropriate).

### 1-5. Effects of Embodiment

As described above, according to the first embodiment of the present invention, it is possible to provide the area determination device 2 including: the point cloud acquisition section 80 configured to acquire point cloud data obtained by the laser sensor 10; and the determination section 71 configured to determine whether a representative position of an object region exists in the railway track area or in the platform area, on the basis of the point cloud data and the criterion function that serves as a standard for determining the area where the representative position of the object region exists.

Such a configuration makes it possible to determine the area where the representative position of the object region exists, on the basis of point cloud data and a preset criterion function. This makes it possible to save user's time and effort to set detection areas. In addition, such a configuration makes it possible to directly recognize an area where the representative position of the object region currently exists. This makes it possible to improve accuracy of determination of the representative position of the object region.

The effects according to the first embodiment of the present invention have been described above.

### 2. SECOND EMBODIMENT

Next, details a second embodiment of the present invention will be described.

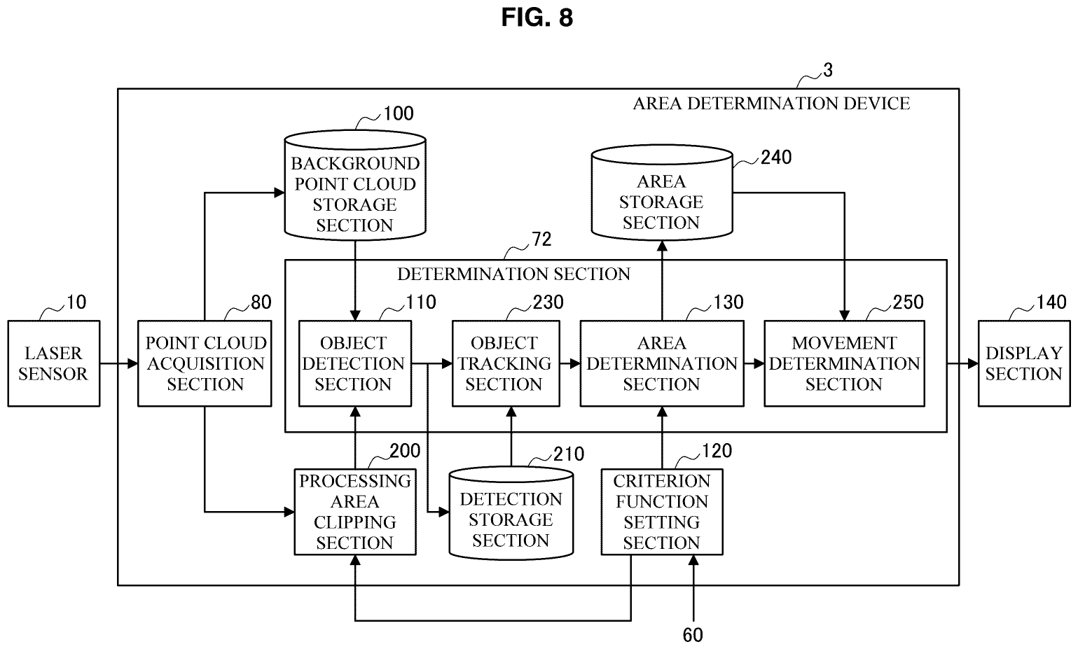

Similar to the information processing system according to the first embodiment of the present invention, an information processing system according to the second embodiment of the present invention includes the criterion function decision device 1 and the laser sensor 10. However, the information processing system according to the second embodiment of the present invention is different from the information processing system according to the first embodiment of the present invention in that the information processing system according to the second embodiment includes an area determination device 3 (FIG. 8) instead of the are determination device 2 (FIG. 2).

Accordingly, the following description mainly focuses on the area determination device 3 included in the information processing system according to the second embodiment of the present invention, and detailed descriptions about the criterion function decision device 1 and the laser sensor 10 will be omitted.

### 1-2. Configuration Example of Area Determination Device 3

FIG. 8 is a block diagram illustrating a functional configuration example of the area determination device 3 according to the second embodiment of the present invention. As illustrated in FIG. 8, similar to the area determination device 2 according to the first embodiment of the present invention, the area determination device 3 according to the second embodiment of the present invention includes the point cloud acquisition section 80, the background point cloud storage section 100, and the criterion function setting section 120. However, the area determination device 3 according to the second embodiment of the present invention is different from the area determination device 2 according to the first embodiment of the present invention in that the area determination device 3 according to the second embodiment includes a determination section 72 instead of the determination section 71, and includes a processing area clipping section 200, a detection storage section 210, and an area storage section 240.

Accordingly, the following description mainly focuses on the determination section 72, the processing area clipping section 200, the detection storage section 210, and the area storage section 240 according to the second embodiment of the present invention, and detailed descriptions about the point cloud acquisition section 80, the background point cloud storage section 100, and the criterion function setting section 120 will be omitted.

### (Area Determination Device 3)

The area determination device 3 is an information processing device that is implemented by a computer. For example, the determination section 72 and the processing area clipping section 200 may be implemented by control units (not illustrated). On the other hand, the detection storage section 210 and the area storage section 240 may be implemented by storage sections (not illustrated).

### (Processing Area Clipping Section 200)

On the basis of the criterion function set by the criterion function setting section 120, the processing area clipping section 200 identifies a determination target area determined by the determination section 72 as a processing area. Next, the processing area clipping section 200 acquires point cloud data in the processing area from point cloud data acquired by the point cloud acquisition section 80. The processing area clipping section 200 outputs the point cloud data in the processing area to the object detection section 110.

### (Determination Section 72)

The determination section 72 determines whether the representative position of the object region exists in the platform area or in the railway track area, on the basis of the criterion function set by the criterion function setting section 120 and the point cloud data clipped by the processing area clipping section 200. In such a way, the point cloud data to be used by the determination section 72 to make a determination is limited to the point cloud data in the processing area, and this makes it possible to shorten time it takes for the determination section 72 to make a determination.

Similar to the determination section 71 according to the first embodiment of the present invention, the determination section 72 includes the object detection section 110 and the area determination section 130. However, the determination section 72 is different from the determination section 71 according to the first embodiment of the present invention in that the determination section 72 includes an object tracking section 230 and a movement determination section 250. Accordingly, the following description mainly focuses on the object tracking section 230 and the movement determination section 250 according to the second embodiment of the present invention, and detailed descriptions about the object detection section 110 and the area determination section 130 will be omitted.

### (Detection Storage Section 210)

The detection storage section 210 stores, as a representative position of an object region in a past frame, a representative position of the object region detected by the object detection section 110 from the point cloud data (hereinafter, also referred to as “past frame”) that has been detected by the laser sensor 10 before. In addition, the detection storage section 210 outputs the representative position of the object region in the past frame to the object tracking section 230.

(Object Tracking Section 230) The object tracking section 230 tracks an object on the basis of the representative position of the object region in the past frame and a representative position of the object region detected by the object detection section 110 from point cloud data (hereinafter, also referred to as “current frame”) that is detected by the laser sensor 10 this time. The representative position of the object region in the past frame may correspond to a first object region at a first time. The representative position of the object region in the current frame may correspond to a second representative position of a second object region at a second time after the first time.

More specifically, the object tracking section 230 calculates a distance between a representative position of an object region in the current frame and a representative position of the object region in the past frame. In a case where the calculated distance is smaller than a threshold, the representative position of the object region in the current frame and the representative position of the object region in the past frame are associated as positions of the same object.

### (Area Storage Section 240)

As a past area determination result, the area storage section 240 stores a determination result obtained by the area determination section 130 when determining whether the representative position of the object region in the past frame exists in the railway track area or the platform area. In addition, the area storage section 240 outputs the past area determination result to the movement determination section 250.

### (Movement Determination Section 250)

The movement determination section 250 acquires the past area determination result from the area storage section 240. In addition, as a current area determination result, the movement determination section 250 acquires a determination result obtained by the area determination section 130 when determining whether the representative position of the object region in the current frame exists in the railway track area or the platform area.

To obtain an inter-area movement determination result, the movement determination section 250 determines whether or not the same object has moved between the railway track area and the platform area on the basis of whether the representative position of the object region in the past frame and the representative position of the object region in the current frame are in a same area or in different areas, the representative position of the object region in the past frame and the representative position of the object region in the current frame being associated as the representative positions of the object regions of the same object by the object tracking section 230 on the basis of the past area determination result and the current area determination result.

In addition, the movement determination section 250 outputs the inter-area movement determination result to the display section 140. This makes it possible to control display of the inter-area movement determination result on the display section 140. For example, it is possible for a person to take some measures against the target object when the person visually recognizes the inter-area movement determination result indicating that the representative position of the object region has moved from the platform area to the railway track area. Note that, hereinafter, a situation where the same object moves from the platform area to the railway track area may also be referred to as a situation where the same object “falls” on the railway track area from the platform area. Note that, “drop” is another word for the “fall”.

### 1-3. Behavior Example Related to Area Determination Phase

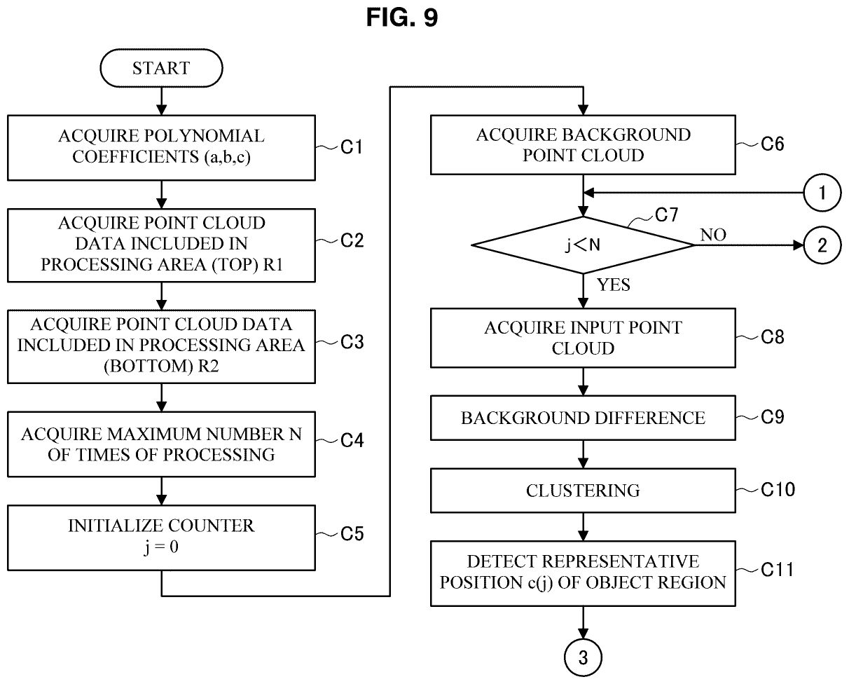

Next, a behavior example of the area determination device 3 related to the area determination phase will be described with reference to FIG. 9 to FIG. 12 (FIG. 2 and FIG. 6 will also be referenced as appropriate). As described above, the area determination phase is performed after the criterion function decision phase.

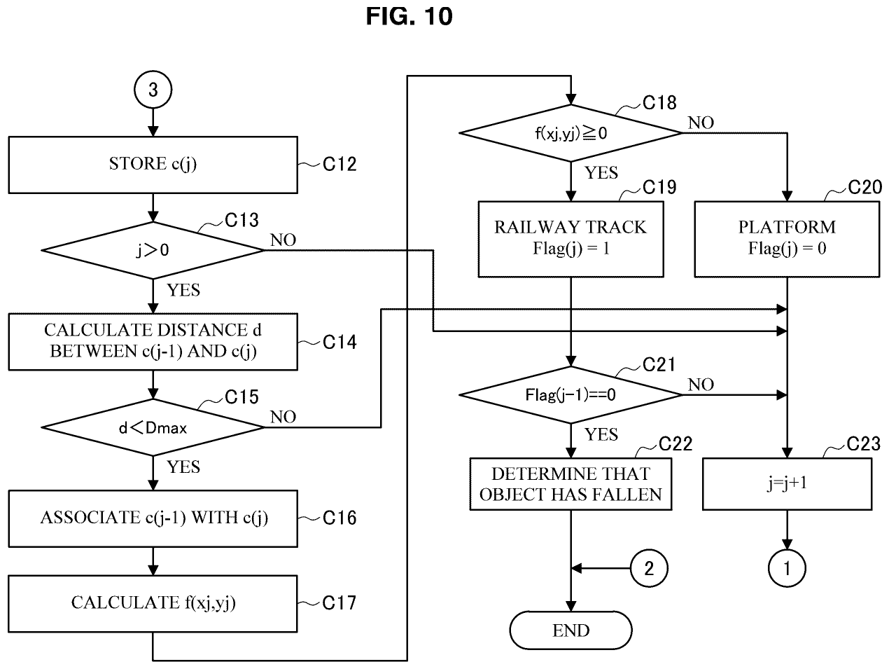

FIG. 9 and FIG. 10 are flowcharts illustrating the behavior example of the area determination device 3 related to the area determination phase. As illustrated in FIG. 9, Step C1 is executed in a way similar to the Step B1 (FIG. 7) that is executed by the area determination device 2 according to the first embodiment of the present invention.

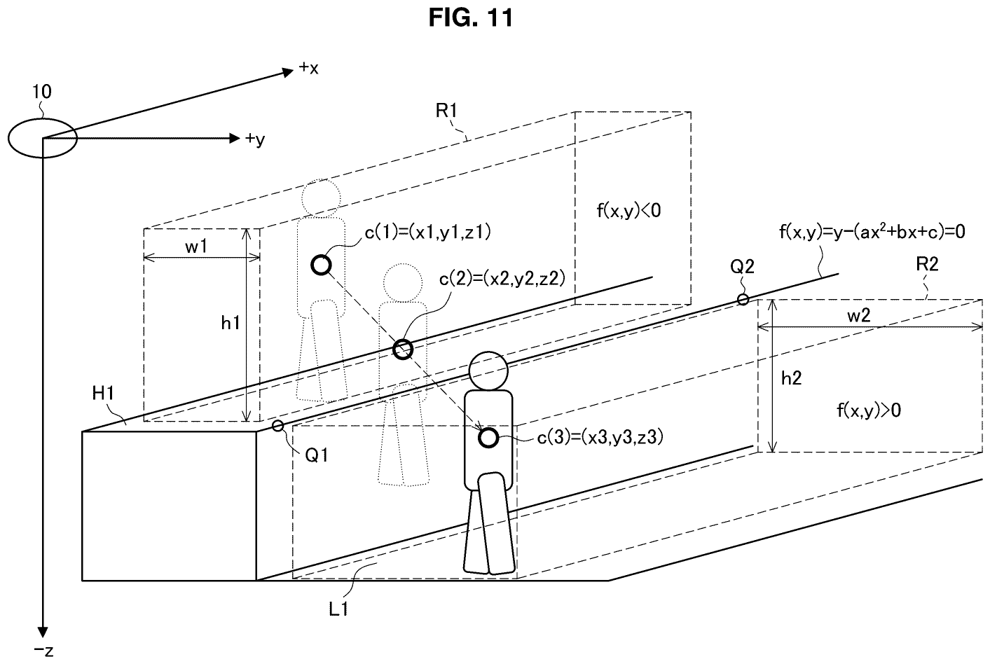

Next, on the basis of the criterion function set by the criterion function setting section 120, the processing area clipping section 200 identifies a determination target area determined by the determination section 72 as a processing area. An example of the processing areas identified by the processing area clipping section 200 will be described with reference to FIG. 11.

FIG. 11 is a diagram illustrating the example of processing areas identified by the processing area clipping section 200. As illustrated in FIG. 11, the following description mainly assumes a case where a processing area (top) R1 and a processing area (bottom) R2 are identified as the example of the processing areas. The processing area (top) R1 may correspond to a first processing area. The processing area (bottom) R2 may correspond to a second processing area. In addition, FIG. 11 illustrates an approximation curve f(x,y)=y−(ax²+bx+c)=0 corresponding to the criterion function f(x,y).

The processing area (top) R1 exists in an area in the sensor coordinate system, the area corresponding to an upper area with respect to a predetermined horizontal plane (for example, platform plane in real space) perpendicular to a vertical direction in the real space. In addition, the processing area (top) R1 exists in one of two areas obtained by splitting a sensor coordinate space xyz (or sensor coordinate plane xy) by the approximation curve f(x,y)=y−(ax²+bx+c)=0 corresponding to the criterion function f(x,y). For example, the one of the two areas is an area that satisfies f(x,y)<0 in the sensor coordinate space xyz (or on the sensor coordinate plane xy). More specifically, when the z-coordinate in the sensor coordinate system is set to z0, the processing area clipping section 200 identifies, as the processing area (top) R1, a processing area having a larger z-coordinate and a smaller y-coordinate than the approximation curve f(x,y)=y−(ax²+bx+c)=0 where z=z0 in the xyz coordinate system that is the sensor coordinate system based on the laser sensor 10. The z-coordinate corresponds to the height of the platform in the real space. Note that, for example, in a case where x and y are switched like an approximation curve h (x,y)=x−(ay²+by +c)=0, a processing area having a larger z-coordinate and a smaller x-coordinate than the approximation curve h (x,y)=0 where z=z0 may be identified as the processing area (top) R1.

In addition, the processing area (bottom) R2 may be an area in the sensor coordinate system, the area corresponding to a lower area with respect to the predetermined horizontal plane perpendicular to the vertical direction in the real space. In addition, the processing area (bottom) R2 exists in another of the two areas obtained by splitting the sensor coordinate space xyz (or sensor coordinate plane xy) by the approximation curve f(x,y)=y−(ax²+bx+c)=0 corresponding to the criterion function f(x,y). For example, the other of the two areas is an area that satisfies f(x,y)≥0 in the sensor coordinate space xyz (or on the sensor coordinate plane xy). More specifically, the processing area clipping section 200 identifies, as the processing area (bottom) R2, a processing area having a smaller z-coordinate and a larger y-coordinate than the approximation curve f(x,y)=y−(ax²+bx+c)=0 where z=z0. Note that, for example, in a case where x and y are switched like the approximation curve h (x,y)=x−(ay²+by +c)=0, a processing area having a smaller z-coordinate and a larger x-coordinate than the approximation curve h (x,y)=0 where z=z0 may be identified as the processing area (top) R2.

Note that, in the example illustrated in FIG. 11, the processing area (top) R1 has a length from a point Q1 to a point Q2 along the approximation curve f(x,y)=0 in the x-axis direction, a width w1 in the y-axis direction, and a height h1 in the z-axis direction. On the other hand, the processing area (bottom) R2 has the length from the point Q1 to the point Q2 along the approximation curve f(x,y)=0 in the x-axis direction, a width w2 in the y-axis direction, and a height h2 in the z-axis direction.

The processing area clipping section 200 acquires point cloud data in the processing area (top) R1 from point cloud data acquired by the point cloud acquisition section 80 (Step C2). In addition, the processing area clipping section 200 acquires point cloud data in the processing area (bottom) R2 from the point cloud data acquired by the point cloud acquisition section 80 (Step C3). The processing area clipping section 200 outputs the acquired point cloud data to the object detection section 110.

Next, the point cloud acquisition section 80 acquires a preset maximum number N of times of processing (Step C4). In addition, the point cloud acquisition section 80 initializes the counter j to count the number of times of processing, by setting the counter j to 0 (zero) (Step C5).

Next, Step C6 is executed in a way similar to the Step B2 (FIG. 7) that is executed by the area determination device 2 according to the first embodiment of the present invention.

The point cloud acquisition section 80 determines whether or not the counter j is smaller than the maximum number N of times of processing (Step C7). The point cloud acquisition section 80 stops its behavior in a case where it is determined that the counter j is equal to or greater than the maximum number N of times of processing (“NO” in Step C7). On the other hand, the point cloud acquisition section 80 proceeds to Step C8 in a case where it is determined that the counter j is smaller than the maximum number N of times of processing (“YES” in Step C7).

Next, Steps C8 to C10 are executed in ways similar to the Steps B3 to B5 (FIG. 7) that is executed by the area determination device 2 according to the first embodiment of the present invention.

The object detection section 110 treats the extracted cluster as a detected-object point cloud, and detects a region as an object region, the region including the detected-object point cloud and having a predetermined shape. Next, the object detection section 110 detects a representative position c(j) of the object region (Step C11).

For example, FIG. 11 illustrates an example in which the object detection section 110 detects a center position of the object region as a representative position c(1)=(x1,y1,z1) of the object region. In a similar way, FIG. 11 illustrates c(2)=(x2,y2,z2) and c(3)=(x3,y3,z3) that are the representative position after the representative position c(1) has moved in this order with movement of the person serving as an example of the target object. The object detection section 110 causes the detection storage section 21 to store the representative position c(j) by outputting the representative position c(j) of the object region to the detection storage section 210 (Step C12).

Next, the object tracking section 230 determines whether or not the counter j is larger than 0 (Step C13). The process proceeds to Step C23 in a case where it is determined that the counter j is 0 or less (“NO” in Step C13). On the other hand, in a case where it is determined that the counter j is larger than 0 (“YES” in Step C13), the object tracking section 230 calculates a distance d between the representative position c(j) of the object region in the current frame and a representative position c(j−1) of the object region in the past frame (Step C14). For example, in a case where the distance d is the Euclidean distance, the distance d is calculated by an expression (2) listed below.

$$d ( c ( j ) , c ( j - 1 ) ) = sqrt ( {( xj - x ( j - 1 ) )}^{2} + {( yj - y ( j - 1 ) )}^{2} + {( zj - z ( j - 1 ) )}^{2} ) \qquad ( 2 )$$

The object tracking section 230 determines whether or not the distance d is smaller than a threshold Dmax (Step C15). The process proceeds to Step C23 in a case where it is determined that the distance d is equal to or greater than the threshold Dmax (“NO” in Step C15). On the other hand, in a case where it is determined that the distance d is smaller than the threshold Dmax (“YES” in Step C15), the object tracking section 230 associates the representative position c(j−1) of the object region in the past frame with the representative position c(j) of the object region in the current frame as positions of the same object (Step C16).

As indicated by an expression (3) listed below, the area determination section 130 calculates an output value f(xj,yj) output from the criterion function f(x,y) (Step C17) in response to input of a representative position c(j)=(xj,yj) of the object region in the current frame into the criterion function f(x,y) as an input value.

$$f ( xj , yj ) = yj - ( {axj}^{2} + bxj + c ) \qquad ( 3 )$$

The area determination section 130 obtains an area determination result by determining whether the representative position c(j) of the object region exists in the platform area or in the railway track area on the basis of the output value f(xj,yj). For example, the area determination section 130 determines whether or not the output value f(xj,yj)≥0 (zero) is satisfied, and obtains an area determination result (Step C18).

In a case where the area determination section 130 determines that the output value f(xj,yj) is 0 or more (“YES” in Step C18), it is determined that the representative position c(j) of the object region exists in the railway track area and Flag(j) indicating the area determination result is set to 1 (=value indicating the railway track area) (Step C19). The area determination section 130 causes the area storage section 240 to store Flag(j) indicating the area determination result and outputs it to the movement determination section 250. Next, the process proceeds to Step C21.

On the other hand, in a case where the area determination section 130 determines that the output value f(xj,yj) is less than 0 (“NO” in Step C18), it is determined that the representative position c(j) of the object region exists in the platform area and Flag(j) indicating the area determination result is set to 0 (=value indicating the platform area) (Step C20). The area determination section 130 causes the area storage section 240 to store Flag(j) indicating the area determination result and outputs it to the movement determination section 250. Next, the process proceeds to Step C23.

The movement determination section 250 determines whether or not the same object has moved between the platform area and the railway track area on the basis of whether or not Flag(j−1) and Flag(j) are the same.

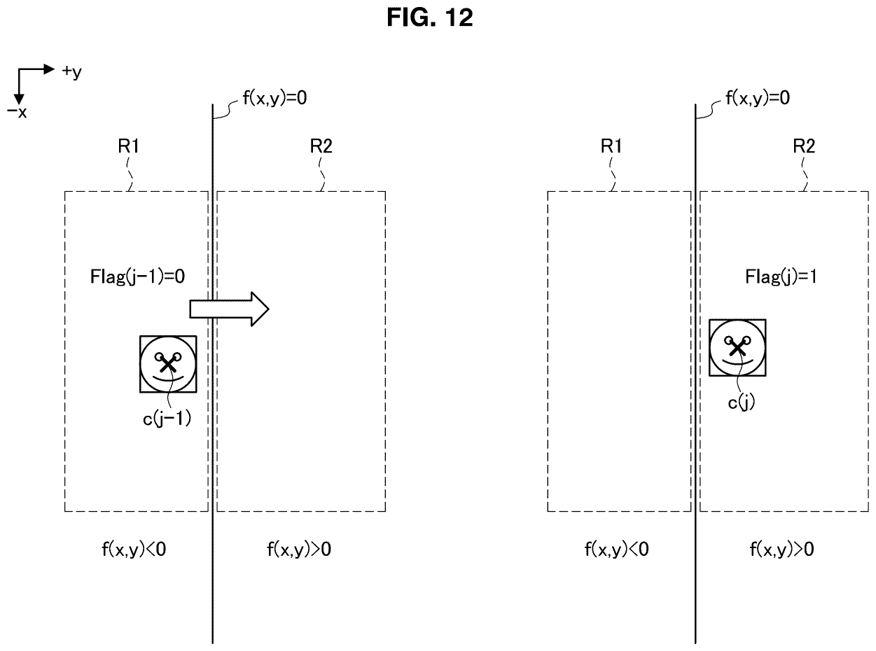

For example, as a representative position of the same object, the movement determination section 250 acquires Flag(j−1) from the area storage section 240. Flag(j−1) indicates a determination result of the representative position c(j−1) of the object region in the past frame associated with the representative position c(j) of the object region in the current frame. Next, a case where the same object falls on the railway track area from the platform area will be described with reference to FIG. 12.

FIG. 12 is a diagram for describing the case where the same object falls on the railway track area from the platform area. As illustrated in FIG. 12, Flag(j−1) is set to 0 (=the value indicating the platform area) in a case where the representative position c(j−1) of the object region exists in the processing area (top) R1. On the other hand, Flag(j−1) is set to 1 (=the value indicating the railway track area) in a case where the representative position c(j) of the object region exists in the processing area (bottom) R2.

In Step C19, Flag(j) has already been set to 1 (=the value indicating the railway track area). Therefore, the movement determination section 250 determines whether or not Flag(j−1) is 0 (Step C21).

In a case where the movement determination section 250 determines that Flag(j−1) is not 0 (“NO” in Step C21), Flag(j−1) and Flag(j) are the same. This means that the same object has not fallen on the railway track area from the platform area. Accordingly, the movement determination section 250 increments the counter j (Step C23). Next, the process proceeds to Step C7.

On the other hand, in a case where the movement determination section 250 determines that Flag(j−1) is 0 (“YES” in Step C21), Flag(j−1) is different from Flag(j). This means that the same object has fallen on the railway track area from the platform area. Therefore, the movement determination section 250 determines that the same object has fallen on the railway track area from the platform area (Step C22).

The movement determination section 250 outputs an inter-area movement determination result to the display section 140. The inter-area movement determination result indicates the falling of the target object on the railway track area from the platform area. Next, the display section 140 displays the inter-area movement determination result. For example, it is possible for a person to take some measures against the target object when the person visually recognizes the inter-area movement determination result indicating that the target object has fallen on the railway track area from the platform area.

The behavior example of the area determination device 3 related to the area determination phase has been described with reference to FIG. 9 to FIG. 12 (FIG. 2 and FIG. 6 have also been referenced as appropriate).

### 2-4. Effects of Embodiment

As described above, according to the second embodiment of the present invention, it is possible to achieve effects similar to the effects according to the first embodiment of the present invention.

In addition, according to the second embodiment of the present invention, the area determination device 3 includes the processing area clipping section 200. This makes it possible to limit the point cloud data to be processed to insides of the processing area (top) R1 and the processing area (bottom) R2. Accordingly, it is possible to shorten processing time and improve accuracy of the determination to determine whether the target object exists in the platform area or in the railway track area.

In addition, according to the second embodiment of the present invention, the area determination device 3 includes the object tracking section 230 and the movement determination section 250. This makes it possible to accurately determine that the same object has fallen on the railway track area from the platform area.

Note that, it is also possible for the area determination device 3 according to the second embodiment of the present invention to include some of the processing area clipping section 200, the object tracking section 230, and the movement determination section 250. For example, the area determination device 3 according to the second embodiment of the present invention may include the processing area clipping section 200 but does not have to include the object tracking section 230 or the movement determination section 250. Alternatively, the area determination device 3 according to the second embodiment of the present invention may include the object tracking section 230 and the movement determination section 250 but does not have to include the processing area clipping section 200.

The effects according to the second embodiment of the present invention have been described above.

### 3. VARIOUS KINDS OF MODIFICATIONS

Next, various kinds of modifications will be described.

### First Modification

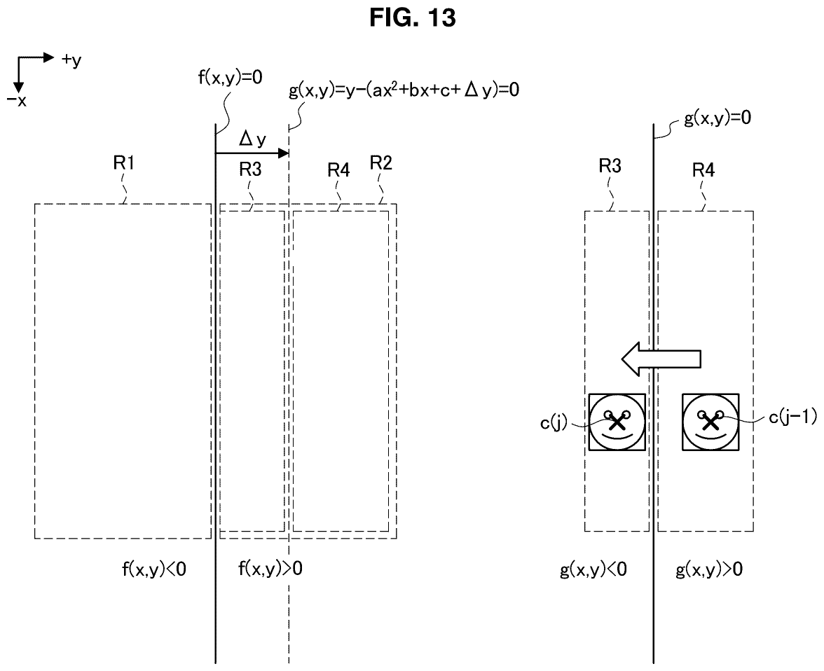

FIG. 13 is a diagram for describing a first modification. As illustrated in a left side of FIG. 13, the second embodiment of the present invention has mainly assumed the case where the determination section 71 determines whether the representative position of the object region exists in the platform area or in the railway track area, on the basis of the criterion function f(x,y) and the input point cloud output from the input point cloud storage section 90. Here, the railway track area may include a third area and a fourth area. Hereinafter, the third area will also be referred to as a “gap area”, between the train and the platform, and the fourth area will also be referred to as a “train area”. In this case, the determination section 71 determines whether the representative position of the object region exists in the gap area or in the train area on the basis of the input point cloud and another criterion function g (x,y) obtained by adding a constant to the criterion function f(x,y).

As illustrated in the left side of FIG. 13, an approximation curve corresponding to the other criterion function may be a curve g (x,y)=y−(ax²+bx+c+Δy)=0 obtained by shifting the approximation curve f(x,y)=0 corresponding to the criterion function f(x,y) decided by approximation, in a positive direction of the y-axis by a width Δy. In other words, the area determination section 130 may obtain the other criterion function g (x,y) by adding the constant Δy to the criterion function f(x,y).

Note that, Δy may be decided in advance. For example Δy may be set to a value similar to the gap between an edge of the platform and the train.

The area determination section 130 may calculates an output value g (xj,yj) output from the other criterion function g (x,y) and may determine whether the representative position c(j) of the object region exists in the gap area or in the train area on the basis of the output value g (xj,yj). For example, the area determination section 130 may determine that the representative position c(j) of the object region exists in the train area in a case where it is determined that the output value g (xj,yj) is 0 or more. On the other hand, the area determination section 130 may determine that the representative position c(j) of the object region exists in the gap area in a case where it is determined that the output value g (xj,yj) is less than 0. Here, as illustrated in a right side of FIG. 13, it is possible to determine whether or not the target object has fallen into the gap between the train and the edge of the platform from the train if the processing area clipping section 200 identifies, as a processing area (top) R4, an area having a larger z-coordinate and a larger y-coordinate than the curve g (x,y)=y−(ax²+bx+c+Δy)=0 corresponding to the other criterion function, and also identifies, as a processing area (bottom) R3, an area having a smaller z-coordinate and a smaller y-coordinate than the curve g (x,y)=y−(ax²+bx+c+Δy)=0 corresponding to the other criterion function.

Note that, the example illustrated in FIG. 13 represents a case where the first modification is applied to the second embodiment of the present invention. However, it is also possible to apply the first modification to the first embodiment of the present invention. In other words, the determination section 71 may determine whether the representative position of the object region exists in the gap area or in the train area on the basis of the input point cloud and the other criterion function g (x,y) obtained by modifying the criterion function f(x,y), but the processing area (top) R4 or the processing area (bottom) R3 does not have to be identified by the processing area clipping section 200.

### Second Modification

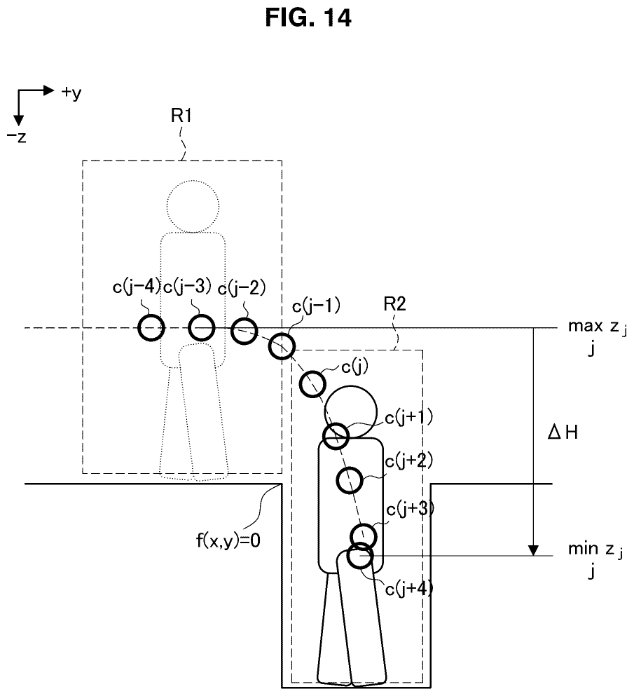

FIG. 14 is a diagram for describing a second modification. The second embodiment of the present invention has mainly assumed the case where it is determined that the same object has fallen on the railway track area from the platform area while c(j−1) and c(j) are associated as representative positions of the object region of the same object, c(j−1) exists in the platform area, and c(j) exists in the railway track area.

However, according to the second embodiment of the present invention, it is also possible for the movement determination section 250 to determine whether or not the same object has fallen on the railway track area from the platform area on the basis of respective z-coordinates of the two representative positions associated as the representative positions of the object region of the same object. More specifically, the movement determination section 250 may determine whether or not the same object has fallen on the railway track area from the platform area on the basis of whether a difference between the respective z-coordinates of the two representative positions associated as the representative positions of the object region of the same object is larger than a predetermined value. Note that, the z-coordinates may correspond to coordinates on a coordinate axis set along the vertical direction in the real space.

The two representative positions may be a maximum value and a minimum value among a plurality of representative positions. FIG. 14 illustrates representative positions c(j−4) to c(j+4) of the object region. Among these representative positions, a z-coordinate of the representative position c(j−4) serves as a maximum value (max zj), and a z-coordinate of the representative position c(j+4) serves as a minimum value (min zj). The movement determination section 250 may determine whether or not the same object has fallen on the railway track area from the platform area on the basis of whether or not a difference ΔH between the maximum value and the minimum value is larger than a predetermined value.

### Third Modification

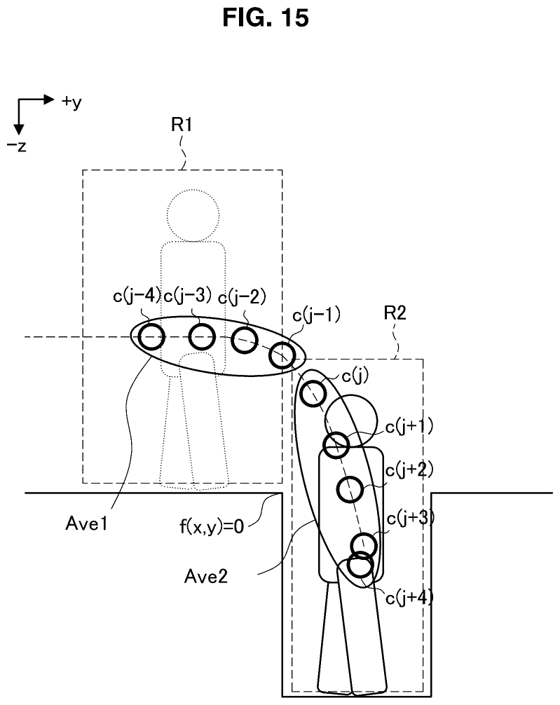

FIG. 15 is a diagram for describing a third modification. The second embodiment of the present invention has assumed the case where the movement determination section 250 determines that the representative positions c(j−1) and c(j) associated as the representative positions of the object region of the same object exist in different areas. More specifically, it has been assumed the case where the movement determination section 250 determines that the representative position c(j−1) exists in the platform area and the representative position c(j) exists in the railway track area.

In such a case, the movement determination section 250 may determines whether or not the same object has fallen on the railway track area from the platform area on the basis of whether or not a difference between a statistical process result (first statistical process result) of the representative positions of the object region of the same object detected at or before the representative position c(j−1) and a statistical process result (second statistical process result) of the representative positions of the object region of the same object detected at or after the representative position c(j) is larger than a predetermined value. This makes it possible to obtain a more accurate determination result.

The statistical process may be a process of calculating an average value. FIG. 15 illustrates the representative positions c(j−4) to c(j−1) of the object region of the same object detected at or before the representative position c(j−1). FIG. 15 also illustrates the representative positions c(j) to c(j+4) of the object region of the same object detected at or after the representative position c(j). The movement determination section 250 may calculate an average value Ave1 of c(j−4) to c(j−1), calculate an average value Ave2 of c(j) to c(j+4), and determine whether or not the same object has fallen on the railway track area from the platform area on the basis of whether or not a difference between the average value Ave1 and the average value Ave2 is larger than a predetermined value.

### Fourth Modification

The above descriptions have mainly assumed the case where the platform edge position acquisition section 40 acquires, as the platform edge position, a position input by a user into a predetermined input device on the basis of an input point cloud displayed on the display. However, it is also possible for the platform edge position acquisition section 40 to automatically acquire the platform edge position without the manual operation by the user.

For example, the platform edge position acquisition section 40 may detect a position of an edge detected from the input point cloud, as the platform edge position.

Alternatively, the platform edge position acquisition section 40 may acquire position information obtained by a global navigation satellite system (GNSS) sensor installed at the platform edge. Next, the platform edge position acquisition section may convert it into position information in the coordinate system of the laser sensor on the basis of a corresponding relation between the coordinate system of the laser sensor 10 and a coordinate system of the GNSS sensor. Next, the platform edge position acquisition section 40 may decide a criterion function by polynomial approximation based on the position information in the coordinate system of the laser sensor 10. The corresponding relation between the coordinate system of the laser sensor 10 and the coordinate system of the GNSS sensor may be measured in advance.

Alternatively, the platform edge position acquisition section 40 may acquire position information obtained by a laser scanner installed at the platform edge. Next, the platform edge position acquisition section 40 may convert it into position information in the coordinate system of the laser sensor 10 on the basis of a corresponding relation between the coordinate system of the laser sensor 10 and a coordinate system of the laser scanner. Next, the platform edge position acquisition section 40 may decide a criterion function by polynomial approximation based on the position information in the coordinate system of the laser sensor 10. The corresponding relation between the coordinate system of the laser sensor 10 and the coordinate system of the laser scanner may be measured in advance.

The various kinds of modifications have been described above.

### 4. HARDWARE CONFIGURATION EXAMPLE

Next, a hardware configuration example of the area determination device 2 according to the embodiment of the present invention will be described. Hereinafter, a hardware configuration example of an information processing device 900 will be described as the hardware configuration example of the area determination device 2 according to the embodiment of the present invention. Note that the hardware configuration example of the information processing device 900 described below is merely an example of the hardware configuration of the area determination device 2. The hardware configuration of the area determination device 2 may accordingly be achieved by removing unwanted components from the hardware configuration of the information processing device 900 described below, or may be achieved by adding new components thereto. Note that, hardware of the criterion function decision device 1 and the area determination device 3 may be achieved in a similar way.

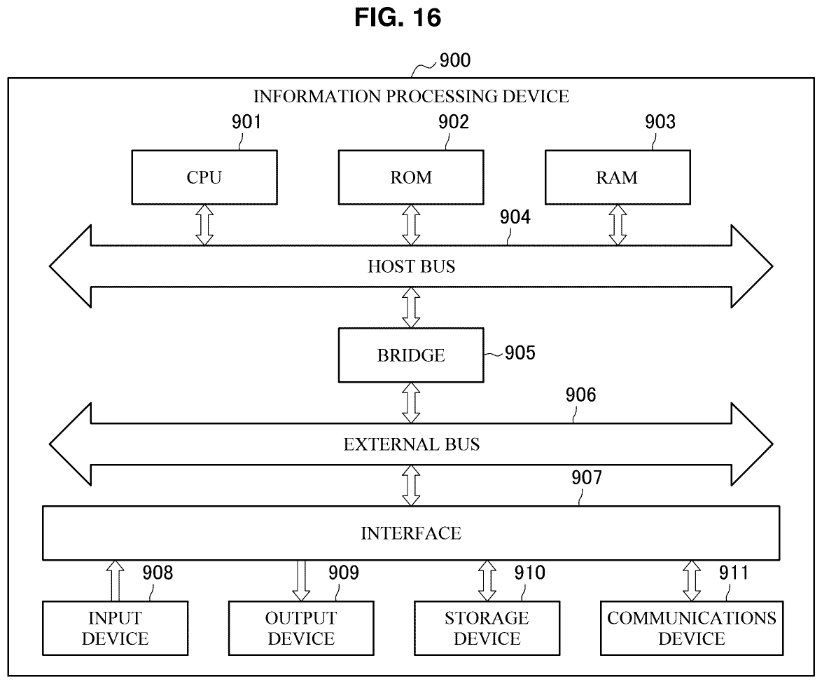

FIG. 16 is a diagram illustrating the hardware configuration of the information processing device 900 serving as an example of the area determination device 2 according to the embodiment of the present invention. The information processing device 900 includes a central processing unit (CPU) 901, read only memory (ROM) 902, random access memory (RAM) 903, a host bus 904, a bridge 905, an external bus 906, an interface 907, an input device 908, an output device 909, a storage device 910, and a communications device 911.

The CPU 901 functions as a computational processing device and a control device, and controls overall operations inside the information processing device 900 according to various programs. The CPU 901 may be a microprocessor. The ROM 902 stores programs, computation parameters, and the like for use by the CPU 901. The RAM 903 temporarily stores programs to be used in execution by the CPU 901, and temporarily stores parameters and the like that are appropriately changed by such execution. These components are connected to each other by the host bus 904 configured by a CPU bus or the like.

The host bus 904 is connected via the bridge 905 to the external bus 906 configured by a Peripheral Component Interconnect/Interface (PCI) bus or the like. Note that the host bus 904, the bridge 905, and the external bus 906 are not necessarily separate configurations, and a configuration may be adopted in which the functionality thereof is implemented by a single bus.

The input device 908 is configured by an input unit for a user to input information with, such as a mouse, keyboard, touch panel, button, microphone, switch, a lever, or the like, and an input control circuit to generate an input signal based on the input by the user, and to output to the CPU 901. By operating the information processing device 900, the user is able to input various data to the information processing device 900 and to instruct processing operations by operating the input device 908.

The output device 909 includes, for example, a display device such as a cathode ray tube (CRT) display device, a liquid crystal display (LCD) display, an organic light emitting diode (OLED) device, or a lamp, and an audio output device such as a speaker.

The storage device 910 is a device employed for data storage. The storage device 910 may include a storage medium, a recording device to record data on the storage medium, a reading device to read data from the storage medium, an erasing device to erase data recorded on the storage medium, and the like. The storage device 910 is, for example, configured by a hard disk drive (HDD). The storage device 910 drives a hard disk, and stores programs executed by the CPU 901 and various data. The communications device 911 is a communication interface configured, for example, by a communication device or the like for connecting to a network. The communications device 911 may be compatible with wireless communication, and may be compatible with wired communication.

The hardware configuration example of the area determination device 2 according to the embodiment of the present invention has been described above.

### 5. SUPPLEMENT

Although details of the preferable embodiments of the present invention have been described above with reference to the appended drawings, the present invention is not limited thereto. It will be clear to a person of ordinary skill in the art of the present invention that various modifications and improvements may be obtained within the scope of the technical idea recited by the scope of the appended claims, and it should be understood that they will naturally come under the technical scope of the present invention.

What is claimed is:

1. An information processing device comprising:
a sensor data acquisition section configured to acquire sensor data obtained by a sensor; and
a determination section configured to determine whether a representative position of an object region exists in a first area or in a second area, on a basis of the sensor data and a criterion function that serves as a standard for determining the area where the representative position exists.

2. The information processing device according to claim 1, comprising
a processing area clipping section configured to clip the sensor data from a predecided processing area,
wherein the determination section determines whether the representative position exists in the first area or in the second area, on a basis of the sensor data and the criterion function.

3. The information processing device according to claim 2,
wherein the processing area includes a first processing area in a sensor coordinate system and a second processing area in the sensor coordinate system, the first processing area corresponding to an upper area with respect to a predetermined horizontal plane perpendicular to a vertical direction in a real space, the second processing area corresponding to a lower area with respect thereto.

4. The information processing device according to claim 3,
wherein the first processing area exists in one of two areas obtained by splitting a sensor coordinate space or a sensor coordinate plane by a shape corresponding to the criterion function, and the second processing area exists in another of the two areas.

5. The information processing device according to claim 1,
wherein the determination section includes
an object detection section configured to detect the object region on a basis of the sensor data and detect the representative position of the object region, and
an area determination section configured to determine whether the representative position exists in the first area or in the second area, on a basis of the representative position and the criterion function.

6. The information processing device according to claim 5,
wherein the area determination section acquires an output value output from the criterion function in response to input of the representative position into the criterion function as an input value and determines whether the representative position exists in the first area or in the second area on a basis of the output value.

7. The information processing device according to claim 5, wherein
the object detection section detects a first representative position of a first object region at a first time and a second representative position of a second object region at a second time that is after the first time,
the determination section includes an object tracking section configured to calculate a distance between the first representative position and the second representative position and associate the first representative position with the second representative position in a case where the distance is smaller than a threshold, and
the determination section includes a movement determination section configured to determine whether or not a same object has moved between the first area and the second area, on a basis of whether the first representative position and the second representative position that are associated with each other exist in a same area or in different areas.

8. The information processing device according to claim 7,
wherein, in a case where it is determined that the first representative position and the second representative position that are associated with each other exist in the different areas, the movement determination section determines whether or not the same object has moved between the first area and the second area, on a basis of whether or not a difference between a first statistical process result of representative positions of an object region of the same object at or before the first time and a second statistical process result of representative positions of an object region of the same object at or after the second time is larger than a predetermined value.

9. The information processing device according to claim 8, wherein
a coordinate axis is set along a vertical direction in a real space,
the first statistical process result is an average value of coordinates on the coordinate axis with regard to the representative positions of the object region of the same object at or before the first time, and
the second statistical process result is an average value of coordinates on the coordinate axis with regard to the representative positions of the object region of the same object at or after the second time.

10. The information processing device according to claim 5, wherein
the object detection section detects a first representative position of a first object region at a first time and a second representative position of a second object region at a second time that is after the first time,
the determination section includes an object tracking section configured to calculate a distance between the first representative position and the second representative position and associate the first representative position with the second representative position in a case where the distance is smaller than a threshold,
a coordinate axis is set along a vertical direction in a real space, and
the determination section includes a movement determination section configured to determine whether or not a same object has moved between the first area and the second area on a basis of a coordinate on the coordinate axis with regard to the first representative position and a coordinate on the coordinate axis with regard to the second representative position that are associated as the representative positions of the object regions of the same object in a sensor coordinate system based on the sensor.

11. The information processing device according to claim 10,
wherein the movement determination section determines whether or not the same object has moved between the first area and the second area on a basis of whether or not a difference between the coordinate on the coordinate axis with regard to the first representative position and the coordinate on the coordinate axis with regard to the second representative position is larger than a predetermined value.

12. The information processing device according to claim 1,
wherein the criterion function is decided by approximation based on position information input by a user or position information obtained by a GNSS sensor or a laser scanner.

13. The information processing device according to claim 12, wherein
the second area includes a third area and a fourth area, and
the determination section determines whether the representative position exists in the third area or in the fourth area on a basis of the sensor data and another criterion function obtained by adding a constant to the criterion function.

14. The information processing device according to claim 12, wherein
the approximation is polynomial approximation, and
the criterion function is a function expressed by using a polynomial decided by the polynomial approximation.

15. The information processing device according to claim 12,
wherein the criterion function is decided by approximation based on the position information input by the user.

16. The information processing device according to claim 12,
wherein the position information obtained by the GNSS sensor or the laser scanner is converted into position information in a sensor coordinate system based on the sensor, and the criterion function is decided by approximation based on the position information in the sensor coordinate system.

17. An information processing method that is executed by a computer, the information processing method comprising:
acquiring sensor data obtained by a sensor; and
determining whether a representative position of an object region exists in a first area or in a second area on a basis of the sensor data and a criterion function that serves as a standard for determining the area where the representative position exists.

18. A non-transitory computer readable storage medium having recorded thereon a program for causing a computer to functions as:
a sensor data acquisition section configured to acquire sensor data obtained by a sensor; and
a determination section configured to determine whether a representative position of an object region exists in a first area or in a second area, on a basis of the sensor data and a criterion function that serves as a standard for determining the area where the representative position exists.
